(19) United States
(12) Patent Application Publication
(10) Pub. No.: US 2019/0054621 A1
(43) Pub. Date: Feb. 21, 2019

(54) Inertial Collision Detection Method For Outdoor Robots

(71) Applicant: Franklin Robotics, Inc., North Billerica, MA (US)

(72) Inventors: Rory MacKean, Concord, MA (US); Joseph L. Jones, Acton, MA (US); John Chase, Jamestown, RI (US); Jeffrey Vandegrift, Acton, MA (US); Noel Allain, Haverhill, MA (US)

(73) Assignee: Franklin Robotics, Inc.

(21) Appl. No.: 16/103,409

(22) Filed: Aug. 14, 2018

Related U.S. Application Data
(60) Provisional application No. 62/546,081, filed on Aug. 16, 2017.

(51) Int. Cl. B25J 9/16; B25J 11/00

(52) U.S. Cl. CPC B25J 9/1666; B25J 9/1697; B25J 11/008

(57) ABSTRACT

A weeding robot includes a chassis, a motorized cutting subsystem, a drive subsystem for maneuvering the chassis, a weed sensor subsystem on the chassis, and an acceleration sensing subsystem mounted to the chassis. The drive subsystem is controlled to maneuver the chassis about a garden by modulating the velocity of the chassis. Upon detection of a weed, the motorized cutting subsystem is energized to cut the weed. The acceleration of the chassis is determined based on an output of the acceleration sensing subsystem. The drive subsystem is controlled according to one or more preprogrammed behaviors if the determined acceleration of the chassis falls below a predetermined level.

### RELATED APPLICATIONS

This application claims benefit of and priority to U.S. Provisional Application Ser. No. 62/546,081 filed Aug. 16, 2017, under 35 U.S.C. §§ 119, 120, 363, 365, and 37 C.F.R. § 1.55 and § 1.78, which is incorporated herein by this reference.

This application is related to U.S. patent application Ser. No. 15/435,660, Feb. 17, 2017 which is incorporated herein by this reference.

### FIELD OF THE INVENTION

This subject invention relates to robots, preferably an autonomous garden weeding robot.

### BACKGROUND OF THE INVENTION

Weeds reduce yields because they steal water, nutrients, and sunlight from food crops. This represents a significant challenge to all growers. One source states, “Currently, weed control is ranked as the number one production cost by organic and many conventional growers” see Fundamentals of Weed Science, 4^{th} edition, Robert L. Zimdahl, page 308 incorporated herein by this reference. Furthermore, the weed problem is worsening as weeds become resistant to common herbicides. See https://en.wikipedia.org/wiki/GIyphosate incorporated herein by this reference.

Mechanical eradication of weeds would solve the problem of herbicide resistance. Accordingly, this strategy has been pursued by many. See, for example, http://www.bosch-presse.de/presseforum/details.htm?txtID=7361&tk_id=166, incorporated herein by this reference. The challenge is constructing cost-effective implements able to discriminate between weeds and desired crops. Purely mechanical methods are available commercially (see, e.g. http://www.lely.com/uploads/original/Turfcare_US/Files/WeederSpecSheet_FINAL.pdf, incorporated herein by this reference) but are limited in scope. Vision-based methods have not yet proven commercially successful possibly because of the great similarity between weeds and crops during some parts of the growth cycle. See also U.S. Published Patent Application Serial No. 2013/0,345,876 and U.S. Pat. Nos. 5,442,552 and 8,381,501 all incorporated herein by this reference.

### BRIEF SUMMARY OF THE INVENTION

The present invention offers a mechanical eradication method directed by sensors able to discriminate between weeds and crops.

Featured in one embodiment is a weeding robot comprising a chassis, a motorized cutting subsystem, a drive subsystem for maneuvering the chassis, a weed sensor subsystem on the chassis, and an acceleration sensing subsystem mounted to the chassis. A controller subsystem controls the drive subsystem and is responsive to the weed sensor subsystem and the acceleration sensing subsystem. The controller subsystem is configured to control the drive subsystem to maneuver the chassis about a garden by modulating the velocity of the chassis. Upon detection of a weed, the motorized cutting subsystem cuts the weed. The acceleration of the chassis is determined from an output of the acceleration sensing subsystem, and control drive subsystem is controlled according to one or more preprogrammed behaviors if the determined acceleration of the chassis falls below a predetermined level.

The controller subsystem may further be configured to de-energize the motorized cutting subsystem after the chassis has moved a predetermined distance and/or after a predetermined period of time. Preferably, the controller subsystem is configured to maneuver the chassis about the garden in a random or deterministic pattern. The weeding robot may further include at least one battery carried by the chassis for powering the motorized cutting subsystem and the drive subsystem and at least one solar panel carried by the chassis for charging the at least one battery. The controller subsystem may be configured to de-energize the drive subsystem when the battery power is below a predetermined level. In one example, the motorized cutting subsystem includes a motor with a shaft carrying a string rotated below the chassis. The weed sensor subsystem may include at least one capacitance sensor located under the front of the chassis. The preferred capacitance sensor is a capaciflector proximity sensor. Also included may be a crop/obstacle sensor subsystem including at least one forward mounted capacitance sensor. Again, a capaciflector proximity sensor is preferred. The acceleration sensing subsystem may include an inertial measurement unit. The one or more preprogrammed behaviors may include controlling the drive subsystem to reverse the direction of the chassis, to turn the chassis, to cycle reversal and forward movement of the chassis, and/or to increase the velocity of the drive subsystem.

In one example, the controller subsystem modulates the velocity of the chassis by modulating a voltage applied to the drive subsystem according to a predetermined waveform. The controller subsystem preferably determines the acceleration of the chassis by applying a convolution to a signal output by the acceleration sensing subsystem and by computing a root means square value of the convolution of the signal output by the acceleration sensing subsystem.

In one version, the drive subsystem includes a plurality of wheels and a drive motor for each wheel controlled by the controller subsystem. There are preferably four disc shaped wheels and four drive motors and all of the wheels are negatively cambered (e.g., at an angle of 60°). The disc shaped wheels preferably include edge fingers.

Also featured is a ground robot comprising chassis, a drive subsystem for maneuvering the chassis, and an acceleration sensing subsystem mounted to the chassis. A controller subsystem controls the drive subsystem and is responsive to the acceleration sensing subsystem. The controller subsystem is configured to control the drive subsystem to maneuver the chassis by modulating the velocity of the chassis, determine the acceleration of the chassis, and control the drive subsystem according to one or more preprogrammed behaviors if the determined acceleration of the chassis falls below a predetermined level. In some examples, the robot further includes a motorized weed cutting subsystem, and a weed sensor subsystem on the chassis. The controller subsystem is configured to energize the motorized weed cutting subsystem in response to a weed detected by the weed sensing subsystem.

Also featured is a method of maneuvering a ground robot. The velocity of the robot is modulated according to a predetermined waveform. The acceleration of the robot is sensed in its direction of travel. If the acceleration of the robot in the direction of travel falls under a predetermined level, the robot is maneuvered according to one or more preprogrammed behaviors. The method may further include maneuvering the robot in a garden, detecting any weeds in the garden, and cutting the weeds.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1A is a schematic side view of an example of a weeding robot detecting a weed to be cut;

FIG. 1B is a schematic side view of an example of the robot of FIG. 1A detecting a crop plant;

FIG. 1C is a schematic side view of the robot of FIGS. 1A and 1B detecting a sleeve placed around a crop plant seedling;

FIG. 2 is a schematic three dimensional view of an example of a weeding robot in accordance with the invention;

FIGS. 3 and 4 are schematic bottom views of the robot of FIG. 2;

FIG. 5 is another view of the robot of FIGS. 2-4;

FIG. 6 is a flow chart depicting the primary steps associated with an exemplary method of the invention and also describing an example of the primary programming logic of the controller subsystem of a robot;

FIG. 7 is a block diagram showing the primary components associated with the robot of FIGS. 2-5;

FIG. 8 is a block diagram depicting the primary components associated with the electronic circuitry of the robot;

FIG. 9 is a graph of one example of a waveform used to apply a varying voltage to the robot wheel motors to modulate the velocity of the robot chassis;

FIG. 10 is a schematic representation of an example of the acceleration sensing subsystem output when the robot is maneuvering according to the velocity modulation depicted in the FIG. 9;

FIG. 11 is a schematic depiction of an example of the acceleration signal output by the acceleration sensing subsystem when the robot is stuck and/or has encountered an obstacle;

FIG. 12 is a flow chart depicting the primary steps associated with one method of freeing a stuck robot and/or maneuvering a robot which has struck an obstacle and also describing an example of the primary programming logic associated with the controller subsystem of the robot;

FIG. 13 is a flow chart depicting the primary steps associated with de-energizing the drive subsystem and/or the weed whacking motor when if the robot is inverted and also describing an example of the programming logic of the controller subsystem of the robot;

FIG. 14 is a schematic view showing another version of a garden robot in accordance with an example of the invention;

FIG. 15 is a schematic bottom view of the robot of FIG. 14; and

FIGS. 16A and 16B are schematic view comparing the footprints of a conventional four wheel drive robot and an extreme camber wheeled robot wherein the hatched areas represent the projection of the drive wheels onto the ground plane and the cross hatching indicates the ground contact patch for each wheel.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

Disclosed is a mobile robot-based system that eradicates weeds from home gardens. The robot preferably includes an outdoor mobility platform, a renewable power source, sensors able to detect the boundary of the robot's designated operating area, sensors able to detect obstacles, one or more sensors that can detect weeds, and a mechanism for eliminating weeds. Optionally included are a mechanism for driving pests out of the garden, a system for collecting information about soil and plants, and a system for collecting images of plants in the garden for offline analysis of plant health and/or visualization of growth over time. Note that the images may be correlated with robot position for tracking individual plants.

The mobility platform may include four drive wheels each powered by an independent motor controlled by a common microprocessor. One or two top-mounted photovoltaic cells provide power. A preferred garden boundary sensor may be based on capacitance. An obstacle detection sensor may be used as a secondary boundary detection sensor. The primary obstacle detection sensor is preferably based on capacitance. The secondary obstacle sensor may be virtual. It may monitor wheel rotation, drive motor PWMs, three orthogonal accelerometers, three orthogonal gyros, and/or other signals. A computer algorithm combines these signals to determine when the robot is being prevented from moving by an obstacle. The weed sensor, mounted on the bottom of the robot's chassis, is also preferably based on capacitance.

Not all objects the robot encounters are conductive and connected to ground. Because of this, the robot may have at least one additional collision sensing modality. As one example, observing wheel rotation, commanded wheel power, accelerometers, and gyroscopes are used. See for example, A Dynamic-Model-Based Wheel Slip Detector for Mobile Robots on Outdoor Terrain, Iagnemma & Ward, IEEE Transactions on Robotics, Vol. 24, No 4, August 2008, incorporated herein by this reference.

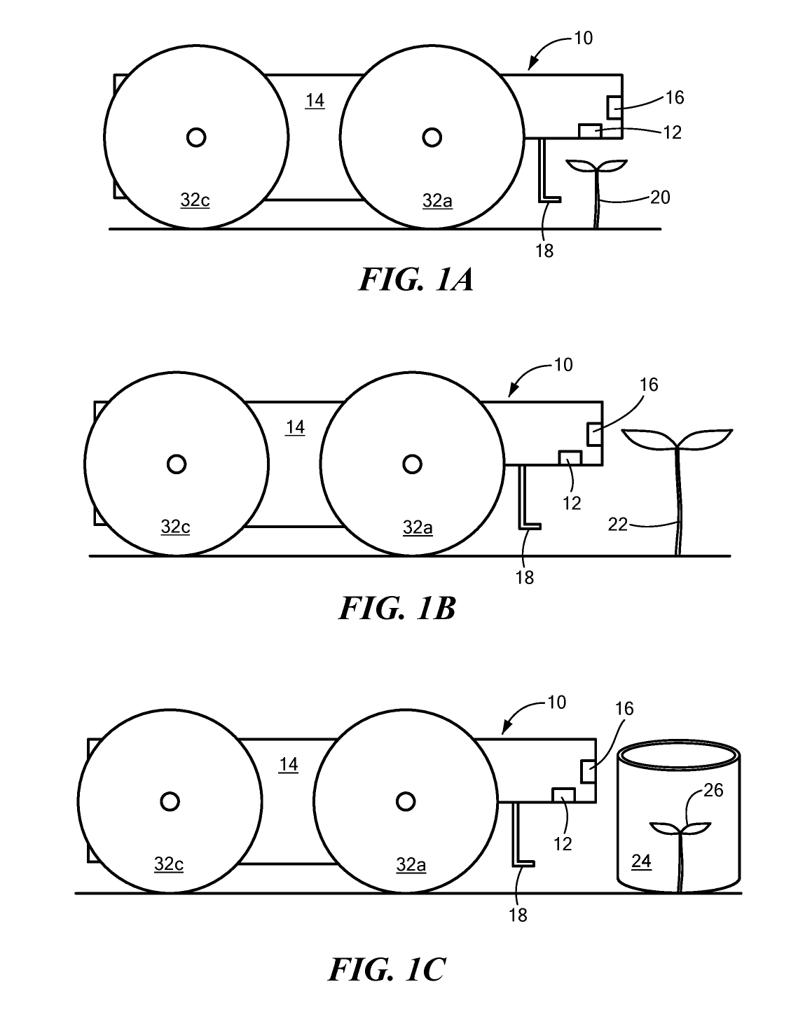

FIG. 1A shows an example of autonomous ground robot 10 with a drive subsystem including driven wheels 32a and 32c. Capacitance weed sensor 12 is preferably located under the forward portion of chassis 14 and capacitive crop/obstacle sensor 16 is preferably mounted higher up and on the front of chassis 14. Weed 20 is detected by weed sensor 12 and in response motorized weed cutter 18 is energized. Optionally, the cutter 18 is energized as robot 10 drives forward. The weed 20 is cut and thereafter the weed cutter 18 is de-energized and turned off (e.g., after a predetermined period of time).

When robot 10, FIG. 1B encounters crop plant 22, crop/obstacle sensor 16 now detects the presence of crop plant 22 and robot 10 turns and maneuvers away from crop plant 22. The weed cutter is not energized. In FIG. 1C, the same result occurs if the robot 10 encounters an obstacle, fence, and/or a conductive sleeve 24 placed around crop plant seedling 26.

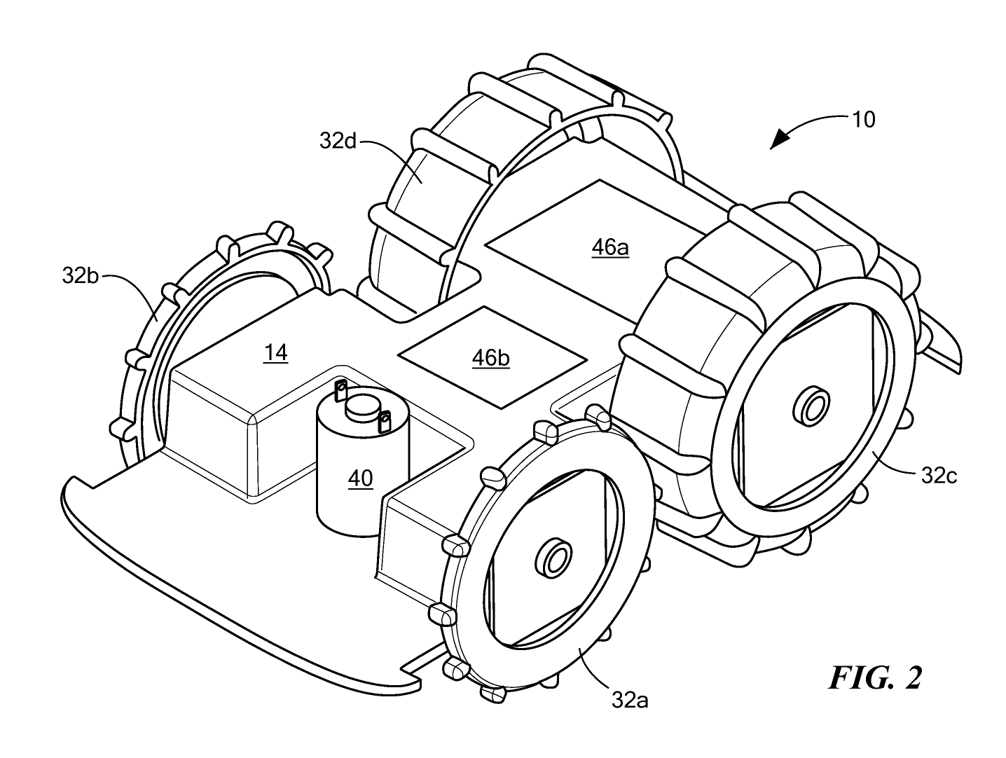

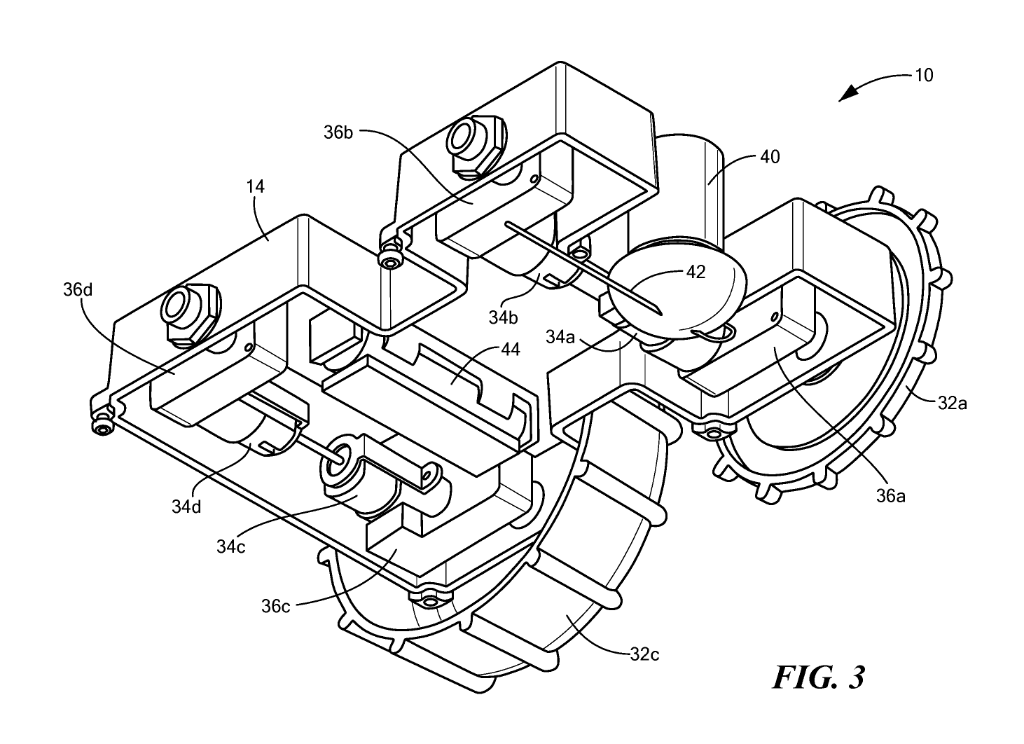

The drive subsystem of robot 10, FIGS. 2-5 may include four driven wheels 32a-32d and four corresponding wheel drive gearboxes 34a-34d each with its own drive motor controller (not shown). Other drive subsystems may be used.

The preferred weed cutting subsystem includes motor 40 driving a line segment 42. Chassis 14 also carries battery 44 charged by one or more solar cells 46a, 46b, and one or more circuit boards for the controller subsystem. The weed sensor 12 is shown and the crop/obstacle sensors 16a, 16b are forward of the robot.

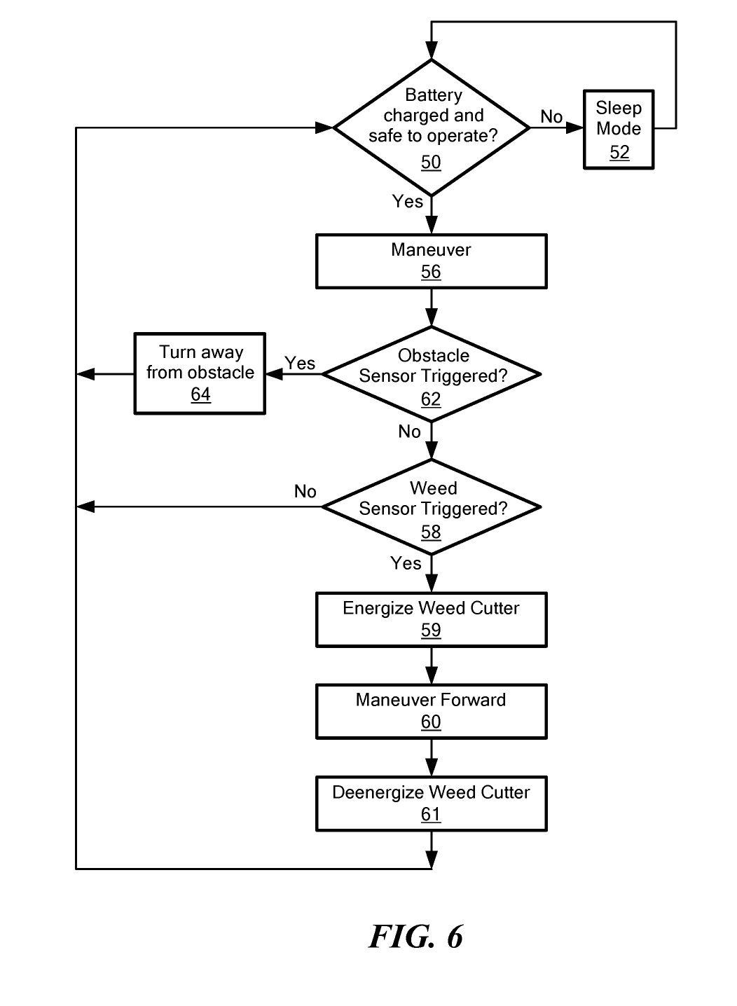

As shown in FIG. 6, the controller subsystem is configured to determine if the battery is charged, step 50 and if not, then to enter a sleep mode, step 52 wherein the robot remains stationary in the garden.

When the battery is sufficiently charged above a predetermined level (e.g., 80%), the controller subsystem controls the drive wheel motors so that the robot maneuvers about the garden preferably in a random fashion for complete coverage, step 56.

When the controller subsystem receives a signal from the weed sensor, step 58, the controller subsystem energizes the weed cutting motor, step 59, and may control the drive wheel motors to drive the robot forward, step 60, over the weed, cutting it. After a predetermined distance traveled and/or after a predetermined time of travel, the controller subsystem de-energizes the weed cutter motor, step 61. In other embodiments, the chassis is not maneuvered forward in order to cut the weed. Then, the weed cutting motor is de-energized after a predetermined time.

As shown in step 62-64, if the controller subsystem receives a signal from the crop/obstacle sensor, the controller subsystem controls the drive wheel motors to turn and steer away from the crop/obstacle. The weed cutter motor is not energized. In other designs, microcontrollers, application specific integrated circuitry, or the like are used. The controller subsystem preferably includes computer instructions stored in an on-board memory executed by a processor or processors. The computer instructions are designed and coded per the flow chart of FIG. 6 and the explanation herein.

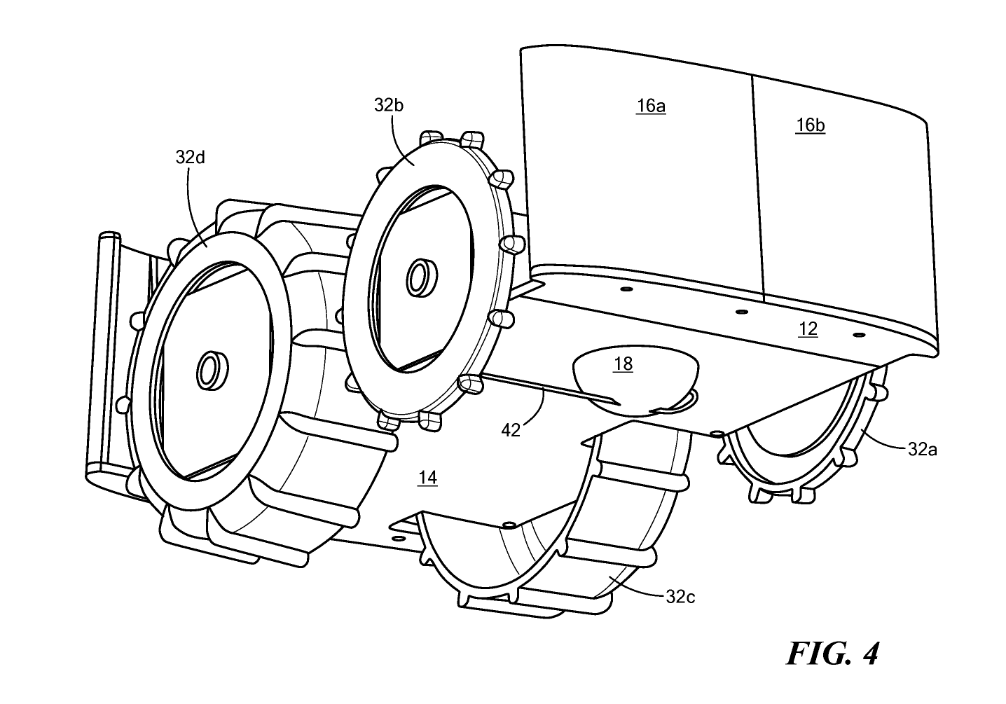

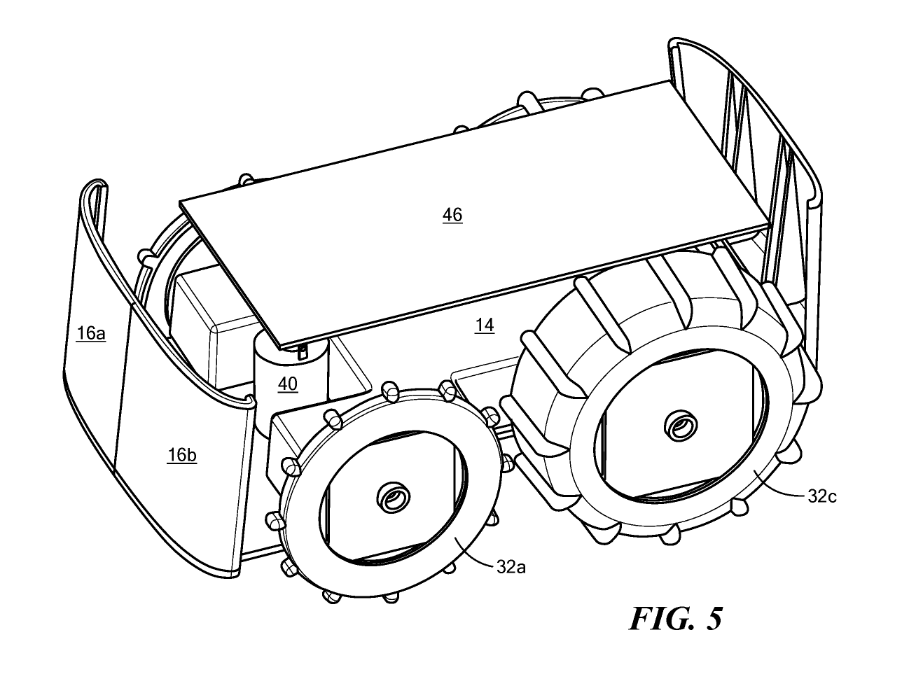

Thus, the robot maneuvers about the garden on a periodic basis automatically cutting weeds and avoiding crops, seedlings, and obstacles. The robot may be 6 to 7 inches wide and 9 to 10 inches long to allow operation in rows of crops. The chassis may also be round (e.g., 7-8 inches in diameter). The robot may weigh approximately 1 kilogram to avoid soil compaction. The robot chassis is preferably configured so the weed sensors are about 1 inch off the ground and the crop/obstacle sensor(s) are about 1½ inch off the ground. The weed cutting line may be 0.5 inches off the ground. Upstanding forward facing right 16a, FIG. 4 and upstanding forward facing left front 16b crop/obstacle sensors may be used and the robot is turned right if the left sensor detects a crop/obstacle and left if the right sensor detects a crop/obstacle. Rear mounted sensors may also be used. In other embodiments, the weed sensor is not included and the weed cutting subsystem is operated whenever the robot is maneuvering.

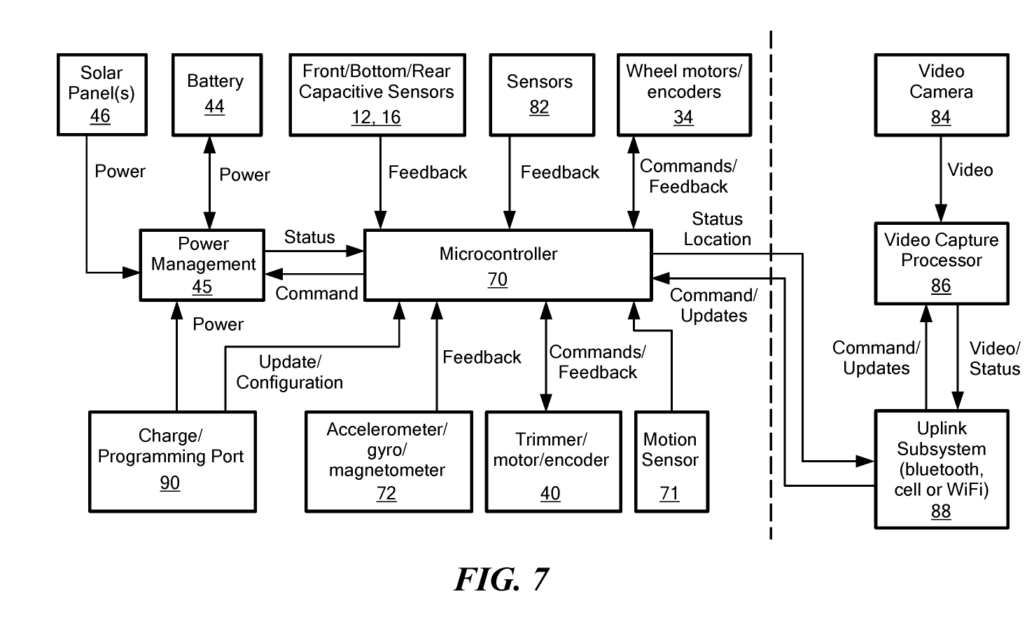

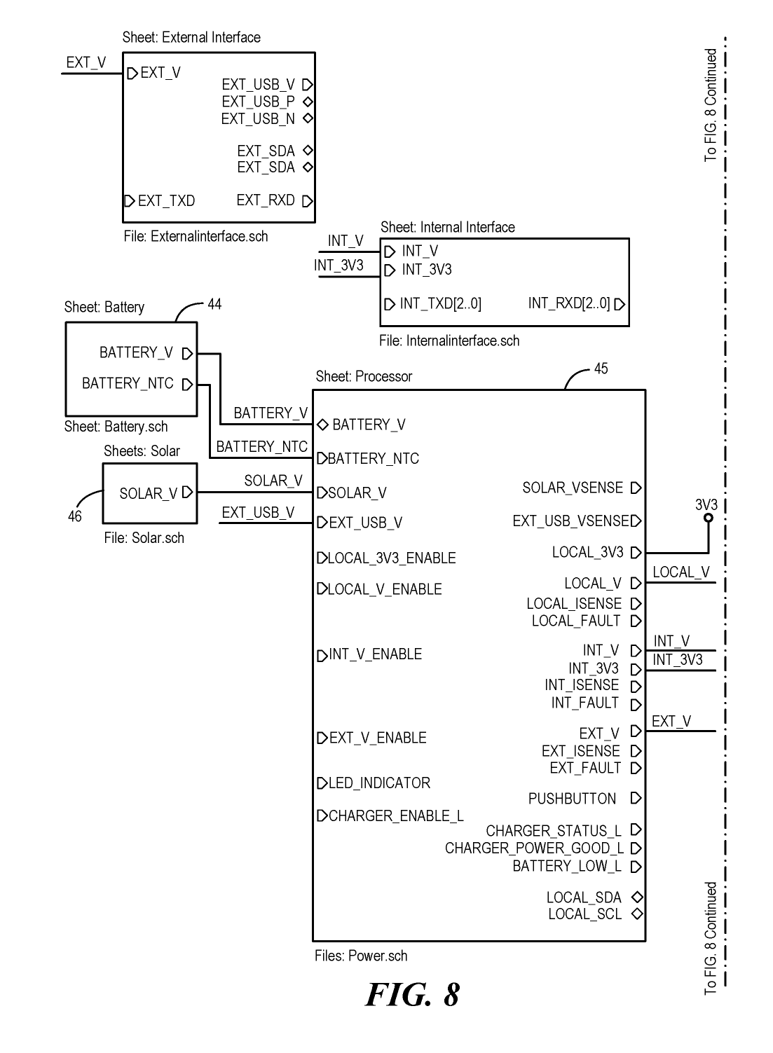

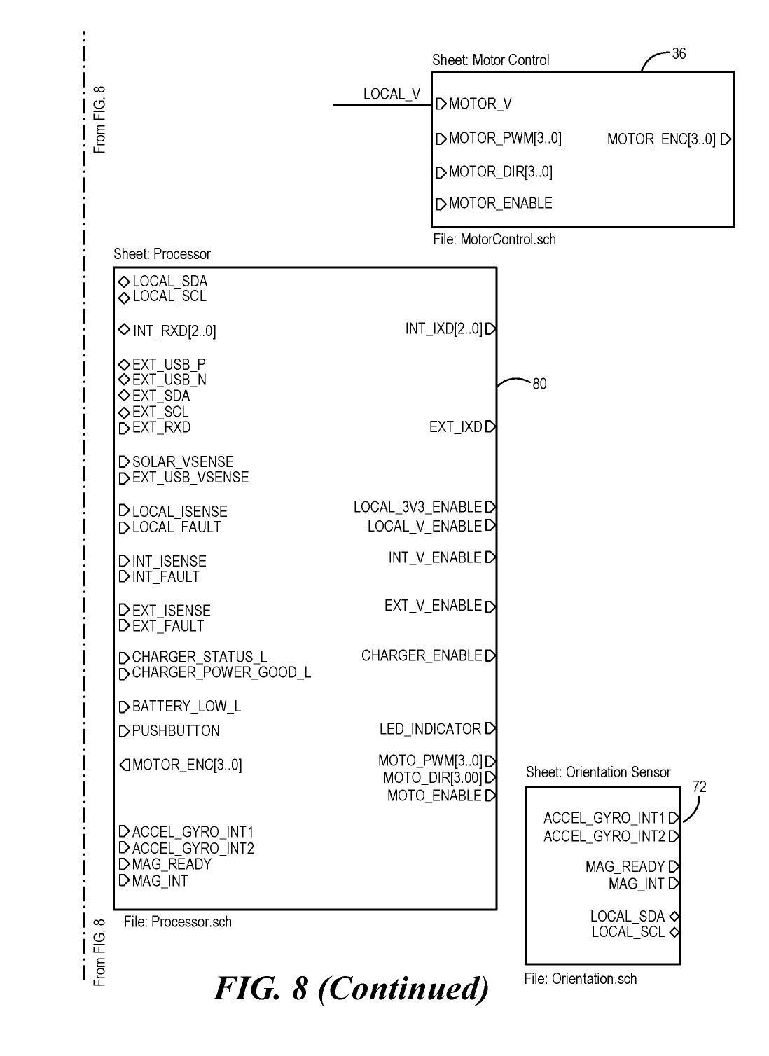

FIG. 7 shows controller subsystem 70 controlling drive motors 34 and weed cutting motor 40 based on inputs from the weed sensor(s) 12, the crop/obstacle sensor(s) 16 and optional motion sensor 71. An optional navigation subsystem 72 may be also included with accelerometers and/or gyroscopes. In one example, the controller subsystem includes a processor 80, FIG. 8. FIGS. 7-8 also show power management controller 45. Further included may be one or more environmental sensors 82, FIG. 7, an imager such as a video camera 84, a video capture processor 86, and an uplink subsystem (e.g., Bluetooth, cellular, or Wi-Fi), 88. FIG. 7 also shows charge and programming port 90.

The following discloses several methods for enhancing the performance of small, inexpensive, outdoor mobile robots—especially robots applied to lawn, garden, and agricultural applications and the robot described previously.

A widely used method for collision detection in mobile robots relies on an instrumented mechanical bumper. See U.S. Pat. No. 6,809,490, incorporated herein by this reference. Although often adequate, such bumpers are mechanically complex, heavy, and prone to failure—especially when working in dusty, dirty, or wet environments. To minimize cost and maximize reliability for small, inexpensive mobile robots we disclose a novel inertial collision detection system.

MEMS-based Inertial Measurement Units, IMUs, have become inexpensive and widely available in recent years. In principle, the signals (accelerations and rotations) measured by an IMU can be integrated to yield the pose (position and orientation) of the robot at any time. Thus one way to determine when the robot has suffered a collision is to monitor the robot's trajectory (as computed by integrating the outputs of the IMU) and declare a collision has occurred when power is applied to the motors but the robot's pose is not changing. Unfortunately, low-cost IMUs may be susceptible to both noise and bias drift to such a degree that the trajectory followed by the robot cannot be computed with sufficient accuracy for this purpose.

The acceleration of the robot along its intended direction of motion is measured using an on-board IMU. An abrupt deceleration in this direction reliably indicates a collision. However, an outdoor robot may encounter loose soil or vegetation that cause it to slow down gradually. Under many circumstances the deceleration caused by collisions with soft obstacles may fall below the noise/drift bias floor of the IMU and the immobilization of the robot becomes undetectable.

In one example, the controller of the robot, controlling the drive subsystem, may constantly modulate the robot's velocity—periodically the robot accelerates then decelerates. When the robot is unimpeded, this modulated acceleration appears prominently in the signal from the IMU. But when the robot presses against an obstacle—whether it has decelerated rapidly or slowly—the modulated acceleration signal disappears from the IMU output.

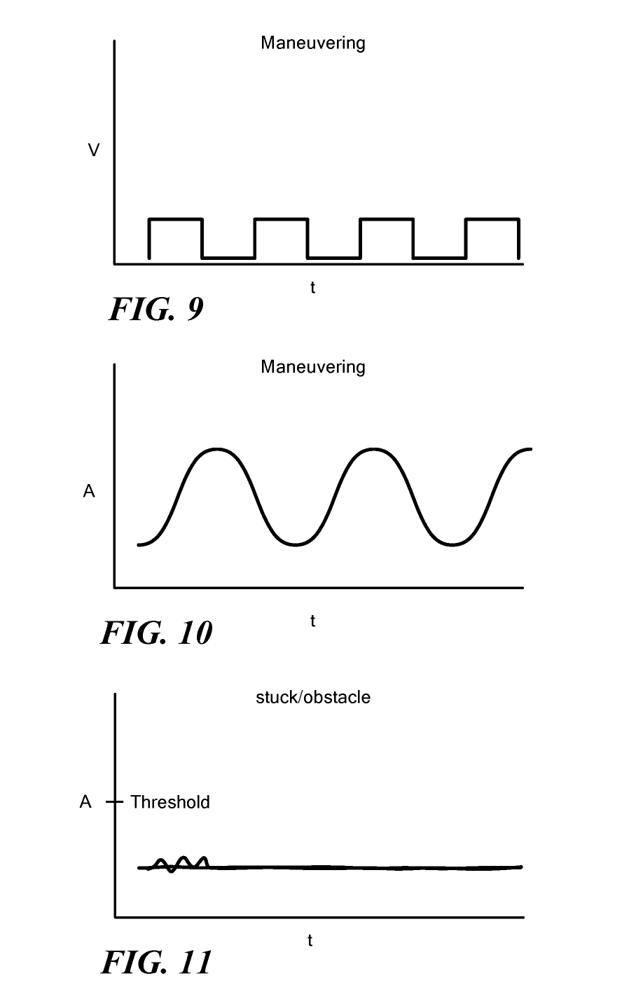

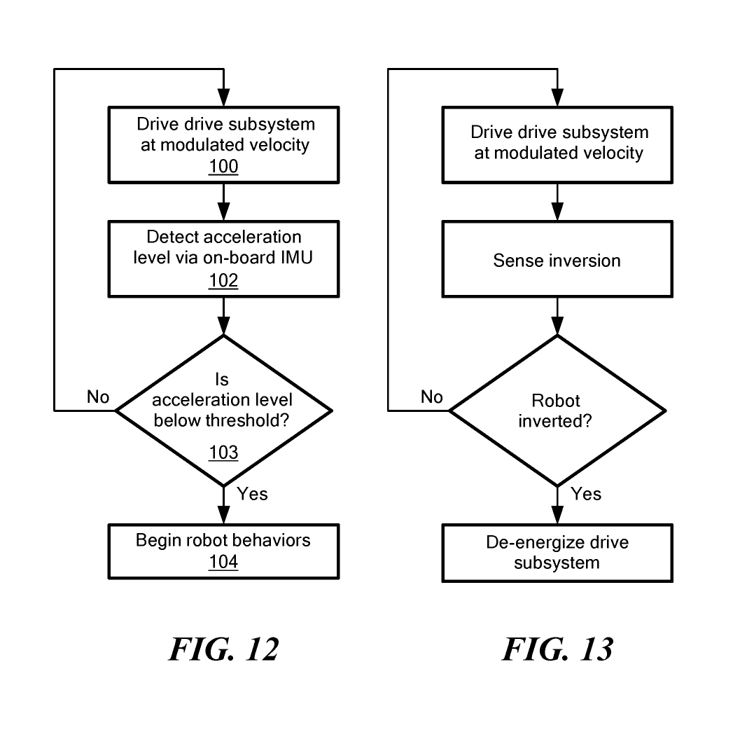

In one example, a controller subsystem (e.g., microcontroller 70, FIG. 7) controls the drive subsystem of the robot (e.g., wheel motors 34) to maneuver the robot chassis about a garden or other area by modulating the velocity of the chassis as shown in FIG. 9. Periodically, the voltage applied to the robot wheel motors is increased and then decreased as shown by the waveform of FIG. 9, step 100, FIG. 12. An acceleration sensing subsystem (e.g., IMU 72, FIG. 7) senses the acceleration of the robot, step 102, FIG. 12 as it is maneuvering as shown in FIG. 10. When, however, the amplitude of the periodic acceleration of the chassis falls below a predetermined level, step 103, FIG. 12, as detected by the acceleration sensing subsystem as shown in FIG. 11 because the robot is stuck or has struck an obstacle, then the controller subsystem controls the robot drive subsystem according to one or more preprogrammed behaviors, step 104, FIG. 11 (e.g., reversing the robot chassis, turning the robot chassis, increasing the velocity of the chassis (e.g., by applying a higher voltage to the drive motors), and/or cycling between reverse motion and forward motion of the chassis) to free the robot if it is stuck or to maneuver the robot away from an obstacle.

Those skilled in the art will recognize that there are many ways to measure the level of modulation present in the acceleration signal. Our preferred embodiment for a robot with a mass of approximately 1 kg is to modulate the commanded velocity of the robot with a square wave having a period of 3.3 Hz. The amplitude of the velocity modulation (and thus acceleration modulation) is chosen to match the capabilities of the IMU. A unit with lower noise can detect a smaller amplitude.

In one preferred implementation, the forward acceleration signal from the on-board IMU is convolved with one cycle of a 3.3 Hz sine wave. The RMS value of the convolution is then compared with a fixed threshold. When the RMS value falls below the threshold the robot is assumed to be in collision with an obstacle or stuck. In response, the controller is programmed to de-energize the drive subsystem, output a signal, or the like.

Note that other convolution kernels are possible but all preferably have zero mean. When the robot points up or down a slope a DC bias is added to the forward acceleration. The zero-mean kernel averages this value out so that only the periodic modulation imposed by the robot appears in the output.

It may possible for the velocity modulation collision detection scheme to be spoofed by certain environmental features. Suppose, for example, that the robot's wheels are stuck in small depressions such that each time an acceleration is applied the robot rocks forward and each time it attempts to decelerate it rocks backward. The acceleration signal is depressed in this case but might still be interpreted as normal forward motion.

An additional sensor 12, FIG. 17 can discover this condition. Suppose that the robot has a downward facing capacitance or proximity sensor. Under normal circumstances the signal from such a sensor matches the undulations in the terrain and is unrelated to the robot's deliberate velocity modulation. However, when the robot is stuck as described above, the signal from the downward pointing sensor becomes well correlated with the acceleration modulation signal. The robot-to-ground distance increases and decreases as the robot rocks forward and back. Thus the controller subsystem can be programmed to look for a correlation between the acceleration and ground proximity signals. Finding a sufficiently strong correlation means that the robot is stuck rather than making progress.

It is advisable to have a means of depowering the robot that is intuitive and always accessible to the user. Because the robot described here is small and light-weight an especially simple method is available. When the robot is inverted it disables all motion. The robot does not reactivate until the user deliberately presses the start button. This scheme also serves as a fail safe method. Should the robot tumble down a slope or otherwise fall over it automatically shuts down until assisted by the user.

If the sensors are arranged as has been described, it is possible that a user may accidentally trigger the weed whacker sensor with their hand if they pick the robot up in an unexpected way. It is possible to detect this situation, however, and disable the weed whacker, even before the robot is inverted, as described above. Due to the arrangement of the plant and weed sensors above, it is extremely likely that the user's hand will trigger one or more of the plant sensors at nearly the same time as the weed sensor. Of course, this combination of sensor inputs happens during normal operation, as well (when a weed sprouts near a plant, for example).

In order to allow for normal operation, while also disabling the weed whacker during pickup, the robot can choose to wait a specified amount of time before enabling the whacker motor. Since the robot will have stopped driving at that point, if the robot detects motion via an onboard accelerometer, inclinometer, or other embedded sensor, it can disable motion in a way similar to the inversion motion disable. See FIG. 13.

A small, inexpensive, mobile robot designed for outdoor use faces daunting mobility challenges. The surface on which the robot operates may include loose soil, mud, rocks, steep slopes, holes, obstacles, and other difficult elements. Yet the size of the robot dictates that its wheelbase is short and ground clearance is small. Furthermore, the robot typically has no advance notice of many imminent hazards. It learns of a mobility problem only after its mobility has been impeded.

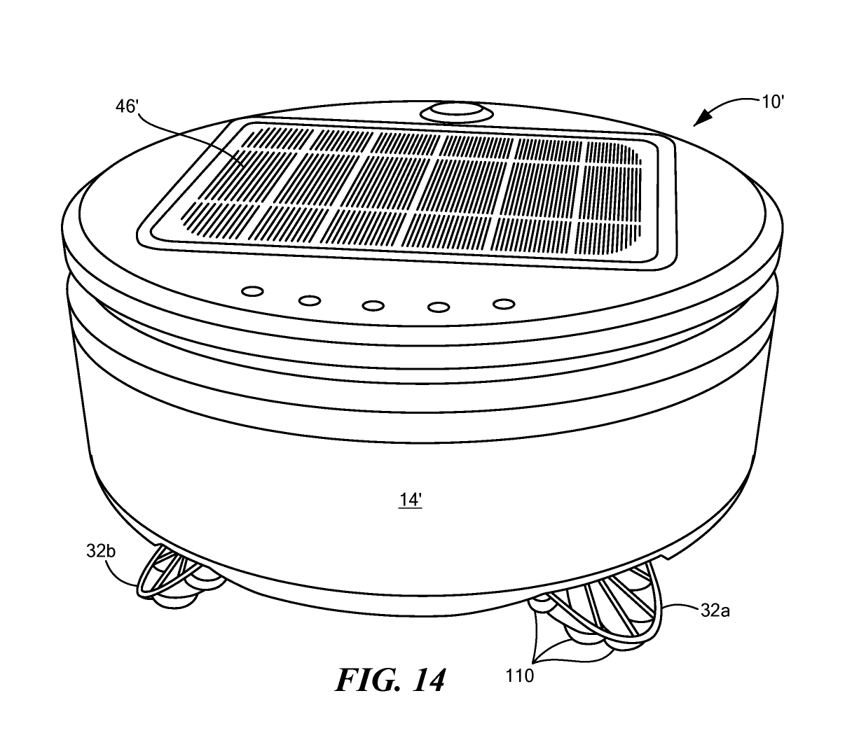

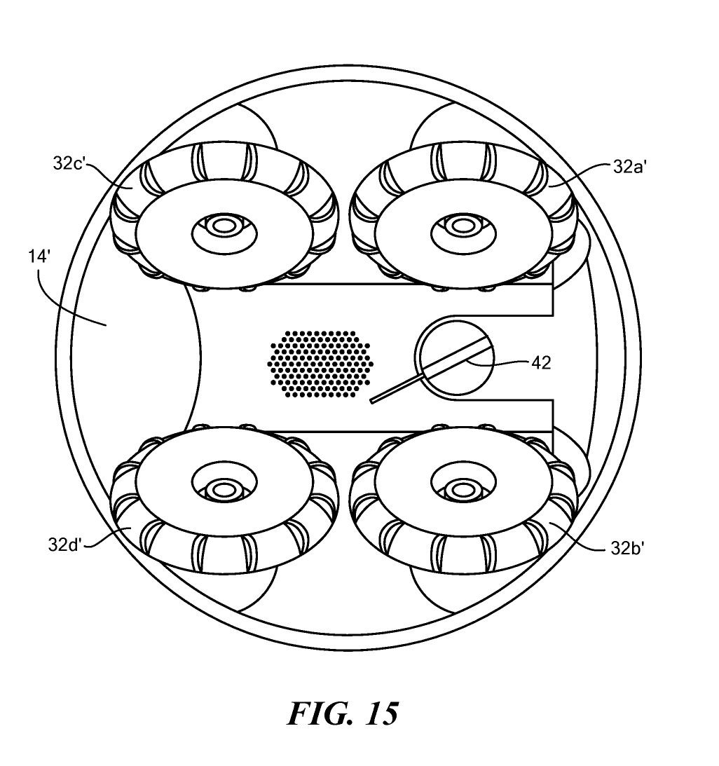

As shown in FIG. 14-15, the robot 10′ includes round chassis 14′ supporting solar panel 46′ and driven by four driven wheels 32 each having a disc shape, a negative camber, (e.g., 60°), and each wheel including spaced edge fingers 110. The result is an improvement in the mobility/autonomy of small, outdoor mobile robots. This method trades away some propulsive efficiency in favor of enhancing the ability of the robot to extricate itself from challenging situations.

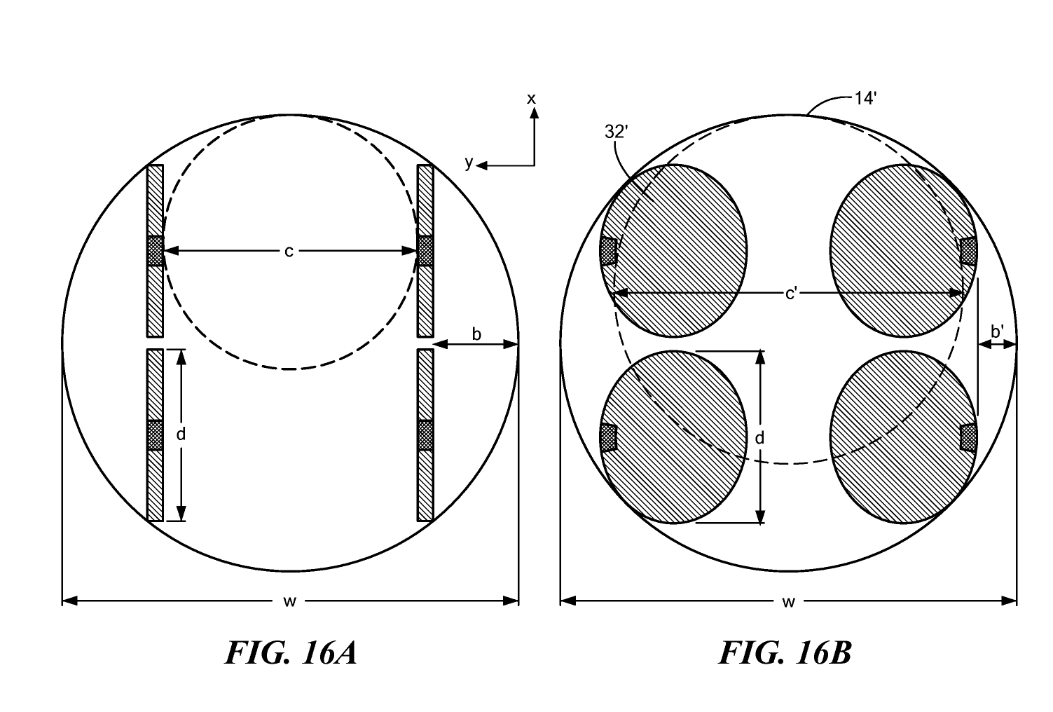

Four wheel drive (4WD) is beneficial to achieving high mobility but configuring the four drive wheels is challenging. To achieve best performance, the mobility system of, say a weeding robot should have the characteristics listed below. First, the width, w, of the robot is as small as possible. See FIGS. 16a and 16b. Narrow width enables the robot to fit between closely planted crops. The narrower the robot, the larger the fraction of the garden the robot is able to visit. Also, the diameter of the drive wheels should be large in order to minimize the effects of sinkage into the terrain.

The drive wheels are also as close to the shell/chassis as possible. The distance between the shell and the wheel, b and b′ in FIG. 16B, is not swept for weeds when the robot follows a row of crops. Thus a weedy boarder of this width will potentially surround plants. The distance between the contact points of the wheels are as large as possible. This gives the robot maximum stability on slopes and minimizes roll and pitch changes as the robot encounters terrain undulations. As large a space as possible must be left under the robot for mounting the weed cutting mechanism, (c′ in FIG. 16B). Maximizing the width of the weed cutting mechanism enables the robot to clear all the weed with fewer passes. The ground clearance of the robot is as large as possible. High ground clearance minimizes the likelihood of the robot becoming high-centered on rocks and other terrain features. The footprint of the robot's propulsive mechanism is as large a fraction as possible of the total footprint of the robot. This minimizes the possibility that the weight of the robot will be supported by a high-centering object rather than by part of the drive mechanism. The open volume around the drive wheels must be as large as possible so that debris is not trapped between the wheel and robot body, thus immobilizing the robot. Propulsive efficiency should be as high as possible to maximize run time on a single battery charge.

The extreme camber wheel configuration (e.g., 60°) offers an improvement over conventional 4WD in eight of the nine desirable listed characteristics. Propulsive efficiency is reduced to achieve all the other desirable traits.

Propulsive efficiency is somewhat reduced when wheel camber becomes extreme because a point on the rim of the drive wheel makes a small motion in the y direction while the wheel is in contact with the ground. The deeper the wheel sinkage the greater the loss of efficiency.

Note that the contact patches of the wheels are configured such that driving the wheels in the same direction causes the robot to move in the +x or −x direction. Driving the wheels on opposite sides of the robot in opposite directions cause the robot to spin in place making a positive or negative rotation.

Note that moving the contact patches of the outwards increases the overall stability of the robot by providing a wider wheelbase.

One disadvantage of traditional (zero-camber) wheels is that they will fling dirt or debris upwards, where it is more likely to settle on top of the robot (which is a disadvantage in the case of robots that have a solar cell mounted on top of the robot). By using wheels with an extreme camber, this loose dirt and debris stays close to the ground.

When emerging weeds are in their “white-thread” or cotyledon development stage they are highly susceptible to disturbances of the soil. Toe-in, toe-out, or high camber configurations cause the wheels to scuff the ground as the robot moves. This action tends to kill weeds before they become visible and is part of the robot's weed eradication strategy.

This strategy may be used on its own, or in conjunction with the previously-described approach of cutting the weeds with a string trimmer.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A weeding robot comprising:
a chassis;
a motorized cutting subsystem;
a drive subsystem for maneuvering the chassis;
a weed sensor subsystem on the chassis;
an acceleration sensing subsystem mounted to the chassis; and
a controller subsystem controlling the drive subsystem and responsive to the weed sensor subsystem and the acceleration sensing subsystem and configured to:
control the drive subsystem to maneuver the chassis about a garden by modulating the velocity of the chassis,
upon detection of a weed, energize the motorized cutting subsystem to cut the weed,
determine the acceleration of the chassis from an output of the acceleration sensing subsystem, and
control the drive subsystem according to one or more preprogrammed behaviors if the determined acceleration of the chassis falls below a predetermined level.

2. The weeding robot of claim 1 in which the controller subsystem is further configured to de-energize the motorized cutting subsystem after the chassis has moved a predetermined distance and/or after a predetermined period of time.

3. The weeding robot of claim 1 in which the controller subsystem is configured to maneuver the chassis about the garden in a random or deterministic pattern.

4. The weeding robot of claim 1 further including at least one battery carried by the chassis for powering the motorized cutting subsystem and the drive subsystem and at least one solar panel carried by the chassis for charging the at least one battery.

5. The weeding robot of claim 4 in which the controller subsystem is further configured to de-energize the drive subsystem when the battery power is below a predetermined level.

6. The weeding robot of claim 1 in which the motorized cutting subsystem includes a motor with a shaft carrying a string rotated below the chassis.

7. The weeding robot of claim 1 in which the weed sensor subsystem includes at least one capacitance sensor located under the front of the chassis.

8. The weeding robot of claim 7 in which the capacitance sensor is a capaciflector proximity sensor.

9. The weeding robot of claim 1 further including a crop/obstacle sensor subsystem including at least one forward mounted capacitance sensor.

10. The weeding robot of claim 9 in which the capacitance sensor is a capaciflector proximity sensor.

11. The weeding robot of claim 1 in which the acceleration sensing subsystem includes an inertial measurement unit.

12. The weeding robot of claim 1 in which said one or more preprogrammed behaviors include controlling the drive subsystem to reverse the direction of the chassis, turn the chassis, cycle reversal and forward movement of the chassis, and/or increase the velocity of the drive subsystem.

13. The weeding robot of claim 1 in which the controller subsystem modulates the velocity of the chassis by modulating a voltage applied to the drive subsystem according to a predetermined waveform.

14. The weeding robot of claim 1 in which controller subsystem determines the acceleration of the chassis by applying a convolution to a signal output by the acceleration sensing subsystem.

15. The weeding robot of claim 14 in which the controller subsystem determines the acceleration of the chassis by computing a root means square value of the convolution of the signal output by the acceleration sensing subsystem.

16. The weeding robot of claim 1 in which the drive subsystem includes a plurality of wheels and a drive motor for each wheel controlled by the controller subsystem.

17. The weeding robot of claim 16 in which there are four wheels and four drive motors.

18. The weeding robot of claim 16 in which the plurality of wheels are cambered.

19. The weeding robot of claim 18 in which the plurality of wheels are cambered at an angle of 60°.

20. The weeding robot of claim 18 in which the plurality of wheels have a negative camber.

21. The weeding robot of claim 20 in which the plurality of wheels are disc shaped.

22. The weeding robot of claim 21 in which the disc shaped wheels include edge fingers.

23. The robot of claim 1 in which the controller subsystem is further configured to disable the motorized cutting subsystem based on the determined acceleration of the chassis.

24. A ground robot comprising:
a chassis;
a drive subsystem for maneuvering the chassis;
an acceleration sensing subsystem mounted to the chassis; and
a controller subsystem controlling the drive subsystem and responsive to the acceleration sensing subsystem and configured to:
control the drive subsystem to maneuver the chassis by modulating the velocity of the chassis,
determine the acceleration of the chassis, and
control the drive subsystem according to one or more preprogrammed behaviors if the determined acceleration of the chassis falls below a predetermined level.

25. The robot of claim 24 further including:
a motorized weed cutting subsystem;
a weed sensor subsystem on the chassis; and
wherein the controller subsystem is configured to energize the motorized weed cutting subsystem in response to a weed detected by the weed sensing subsystem.

26. The robot of claim 24 further including at least one battery carried by the chassis for powering the motorized cutting subsystem and the drive subsystem and at least one solar panel carried by the chassis for charging the at least one battery.

27. The robot of claim 24 in which the motorized cutting subsystem includes a motor with a shaft carrying a string rotated below the chassis.

28. The robot of claim 24 in which the weed sensor subsystem includes at least one capacitance sensor.

29. The robot of claim 24 in which the acceleration sensor subsystem includes an inertial measurement unit.

30. The robot of claim 24 in which said one or more preprogrammed behaviors include controlling the drive subsystem to reverse the direction of the chassis, turn the chassis, cycle reversal and forward movement of the chassis, and/or increase the velocity of the drive subsystem.

31. The robot of claim 24 in which the controller subsystem modulates the velocity of the chassis by modulating a voltage applied to the drive subsystem according to a predetermined waveform.

32. The robot of claim 24 in which controller subsystem determines the acceleration of the chassis by applying a convolution to a signal output by the acceleration sensing subsystem.

33. The robot of claim 32 in which the controller subsystem determines the acceleration of the chassis by computing a root means square value of the convolution of the signal output by the acceleration sensing subsystem.

34. The robot of claim 24 in which the drive subsystem includes a plurality of wheels and a drive motor for each wheel controlled by the controller subsystem.

35. The robot of claim 34 in which the plurality of wheels are cambered.

36. The robot of claim 35 in which the plurality of wheels have a negative camber.

37. The robot of claim 35 in which the plurality of wheels are disc shaped.

38. The robot of claim 37 in which the disc shaped wheels include edge fingers.

39. A method of maneuvering a ground robot, the method comprising:
modulating the velocity of the robot according to a predetermined waveform;
sensing the acceleration of the robot in its direction of travel; and
if the acceleration of the robot in the direction of travel falls under a predetermined level, maneuvering the robot according to one or more preprogrammed behaviors.

40. The method of claim 39 further including maneuvering the robot in a garden, detecting any weeds in the garden, and cutting said weeds.

41. The method of claim 39 in which the robot includes at least one battery, the method including using solar energy to charge the at least one battery.

42. The method of claim 40 in which detecting any weeds in the garden includes employing a capacitance sensor.

43. The method of claim 39 in which sensing the acceleration of the robot includes employing an inertial measurement unit.

44. The method robot of claim 39 in which said one or more preprogrammed behaviors include controlling the drive subsystem to reverse the direction of the chassis, turn the chassis, cycle reversal and forward movement of the chassis, and/or increase the velocity of the drive subsystem.

45. The method robot of claim 39 in which determining the acceleration of the chassis includes applying a convolution to the sensed acceleration.

46. The method robot of claim 45 in which determining the acceleration of the chassis further includes computing a root means square value of the convolution.

47. The method robot of claim 39 further includes equipping the robot with a plurality of wheels and a drive motor for each wheel.

48. The method robot of claim 47 in which the plurality of wheels are cambered.

49. The method robot of claim 48 in which the plurality of wheels have a negative camber.

50. The method robot of claim 49 in which the plurality of wheels are disc shaped.

51. The method robot of claim 50 in which the disc shaped wheels include edge fingers.
